(19) United States
(12) Patent Application Publication
(10) Pub. No.: US 2024/0243770 A1
(43) Pub. Date: Jul. 18, 2024

(54) Push To Talk (PTT) Button and NFC Antenna Assembly

(71) Applicant: 3M INNOVATIVE PROPERTIES COMPANY, St. Paul, MN (US)

(72) Inventors: Darin K. Thompson, Huntersville, NC (US); Eric J. Bassani, Denver, NC (US)

(21) Appl. No.: 18/289,496

(22) PCT Filed: May 4, 2022
(86) PCT No.: PCT/IB2022/054093

§ 371 Date: Nov. 3, 2023

Related U.S. Application Data
(60) Provisional application No. 63/184,607, filed on May 5, 2021.

(51) Int. Cl. H04B 1/3827; A62B 18/08

(52) U.S. Cl. CPC H04B 1/385; A62B 18/08; H04B 2001/3866

(57) ABSTRACT

A communications assembly for a mask. The communications assembly includes a housing configured to couple to the mask, the housing includes a substrate. A push-to-talk (PTT) actuator is coupled to the substrate. A near field communication (NFC) antenna is coupled to the substrate.

### TECHNICAL FIELD

This disclosure relates to a communications assembly for a mask, and in particular, a combination push-to-talk (PTT) and near field communication (NFC) assembly.

### INTRODUCTION

Communication between first responders in immediate dangerous to life or health (IDLH) conditions is essential. The wireless communication methods and options used by first responders is ever increasing, thereby placing a demand to include various antennas and communication peripherals as part of a first responder's equipment. However, this equipment, such as a first responder's mask has limited space within which or on which to couple communications devices, and such communications devices can be bulky or unwieldy if placed in multiple locations on the mask.

### SUMMARY

Some embodiments advantageously provide a communications assembly for a mask. The communications assembly includes a housing configured to couple to the mask, the housing includes a substrate. A push-to-talk (PTT) actuator is coupled to the substrate. A near field communication (NFC) antenna is coupled to the substrate.

In another aspect of this embodiment, the NFC antenna is at least partially circumferentially disposed about a peripheral region of the substrate.

In another aspect of this embodiment, the communications assembly further includes a resilient membrane coupled to the housing and configured to engage the PTT actuator when depressed.

In another aspect of this embodiment, the communications assembly further includes a bezel, and wherein the resilient membrane is at least partially retained by the bezel.

In another aspect of this embodiment, when the resilient membrane is disposed within the housing the resilient membrane is substantially co-planar with the housing.

In another aspect of this embodiment, the housing includes at least one tab, and wherein the resilient membrane includes at least one slot configured to engage the at least one tab.

In another aspect of this embodiment, the communications assembly further includes ferrite shielding coupled to the substrate.

In another embodiment, a mask having a frame is provided. A housing is coupled to the frame, the housing including a communications assembly. The communications assembly includes a substrate. A push-to-talk (PTT) actuator is coupled to the substrate. A near field communication (NFC) antenna is coupled to the substrate.

In another aspect of this embodiment, the NFC antenna is at least partially circumferentially disposed about a periphery of the substrate.

In another aspect of this embodiment, the communications assembly further includes a resilient membrane coupled to the housing configured to engage the PTT actuator when depressed.

In another aspect of this embodiment, the communications assembly further includes a bezel, and the resilient membrane is at least partially retained by the bezel.

In another aspect of this embodiment, when the resilient membrane is disposed within the housing the resilient membrane is substantially co-planar with the housing.

In another aspect of this embodiment, the housing includes at least one tab, and the resilient membrane includes at least one slot configured to engage the at least one tab.

In another aspect, a mask includes a housing coupled to the mask, the housing being configured to contour an outer surface of the mask and including a communications assembly. The communications assembly includes a substrate. A push-to-talk (PTT) actuator is coupled to the substrate. A resilient membrane is coupled to the housing and is configured to engage the PTT actuator when depressed. A bezel is coupled to the housing and is configured to retain the resilient membrane. A film is disposed between the PTT actuator and the resilient membrane. A near field communication (NFC) antenna is circumferentially disposed about a peripheral region of the substrate.

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 is a perspective view of an example mask constructed in accordance with the principles of the application;

FIG. 2 is a dissembled view of the housing for an example communications assembly shown in FIG. 1;

FIG. 3 is a cross-sectional view of the communications assembly shown in FIG. 2;

FIG. 4 is an assembled view of the housing shown in FIG. 2; and

FIG. 5 is a disassembled view of an example substrate assembly shown in FIG. 2.

### DETAILED DESCRIPTION

Before describing in detail exemplary embodiments, it is noted that the embodiments reside primarily in combinations of apparatus components and processing steps related to a communications assembly for a mask. Accordingly, the system and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

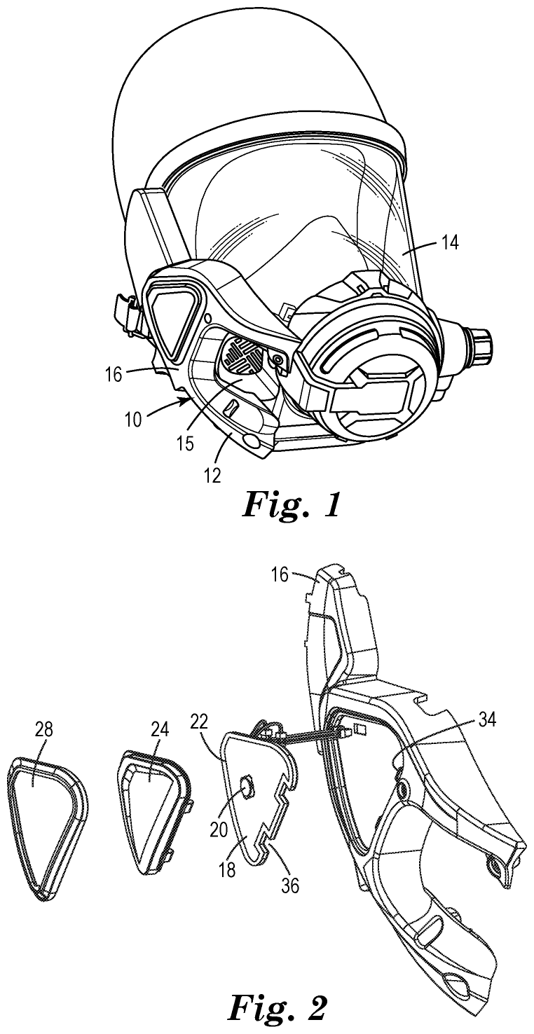

Referring to the drawing figures, in which like reference designators refer to like elements, some embodiments include, as shown in FIG. 1, a communications assembly 10 for a mask 12. In particular, the mask 12 may be one wore by responders which includes a facepiece 14 and a frame 15 extending from the facepiece 14. The communications assembly 10 may be mechanically removably coupled to a housing 16, which in one configuration is coupled to the frame 15. For example, as shown in FIG. 1, the housing 16 contours an exterior portion of a side of the mask 12.

Referring now to FIGS. 1-4, the housing 16 includes a substrate 18 upon which, or to which, the various communications structures are disposed. For example, the substrate 18 includes a push-to-talk (PTT) actuator 20 coupled to the substrate 18. In one configuration, the substrate 18 is substantially triangular in shape, but may be any shape or size. In one configuration, the PTT actuator 20 is a dome-switch disposed at approximately the center of the substrate 18, although any type of switch is contemplated by this disclosure. Also coupled to the substrate 18 and/or etched into the substrate, is a near field communication (NFC) antenna 22. In one configuration, the NFC antenna 22 is at least partially circumferentially disposed about a peripheral region of the substrate 22. For example, the NFC antenna 22 may include a tracing around the circumference of the substrate 18. Such a configuration provides a longer length of NFC antenna 22 with a small footprint.

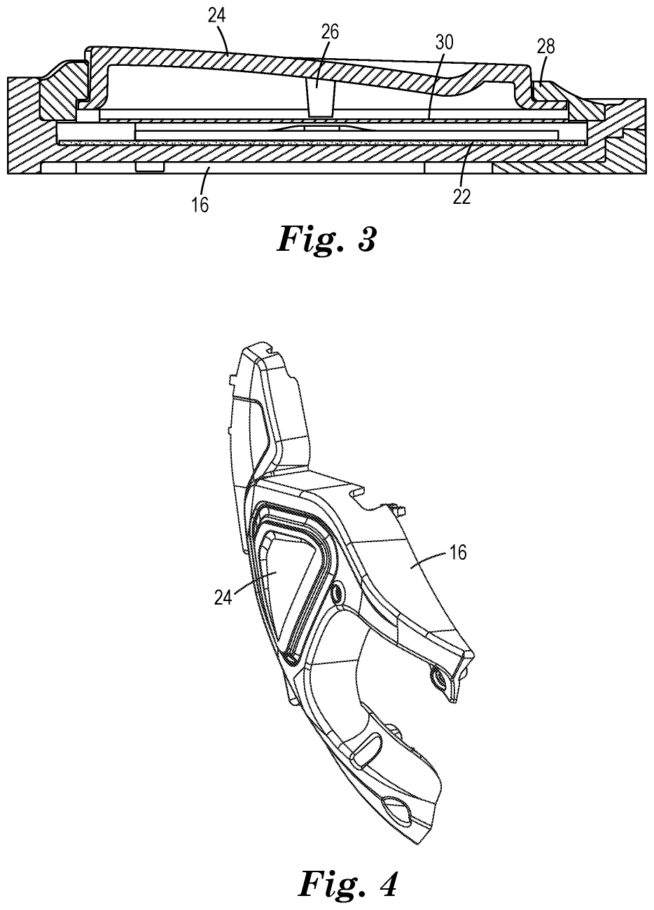

A membrane 24, which may be rigid or flexible, is included in the communications assembly 10 coupled to housing 16 and configured to engage the PTT actuator 20 when depressed. In one configuration, the membrane 24 is silicone that is resilient and deformable when pressed by the wearer of the mask 12. In one configuration, the membrane 24 includes a protrusion 26 (shown in FIG. 3) extending from the membrane 24. An application of force by the wearer of the mask 12 deforms the membrane 24 and pushes on the protrusion 26 which pushes on the PTT actuator 20. In other configurations, the membrane 24 may be a polycarbonate that deforms or rotates by a pair of hinges when a force is applied.

In the illustrated embodiment, a bezel 28 is included in the communications assembly 10 and is configured to at least partially retain the membrane 24. In particular, the bezel 28 is configured to retain the membrane 24 within the housing 16, as shown in FIG. 3. When the membrane 24 is disposed within the bezel 28, and within the housing 16, the membrane 24 is substantially co-planar with the housing 16, as shown in FIG. 4. In some configurations, a film 30 is included between the membrane 24 and the PTT actuator 20. The film 30, which for example, may be a polyester, or other hydrophobic materials, is configured to seal the PTT actuator 20 within the housing 16 from the exterior environment such as may be needed for an intrinsically safe device operable in a hazardous environment. Additionally, ferrite shielding 32 may be included beneath and coupled to the substrate 18 which is configured to prevent interference between the NFC antenna 22 and the other communications components of the mask 12. To mechanically couple the communications assembly 10 to the housing 16, the housing includes at least one tab 34, and in one configuration two tabs 34, configured to engaged corresponding hinges 36 on the membrane 24 such that the membrane 24 snaps into the housing 16 or otherwise is configured to rotate when a force is applied to the membrane.

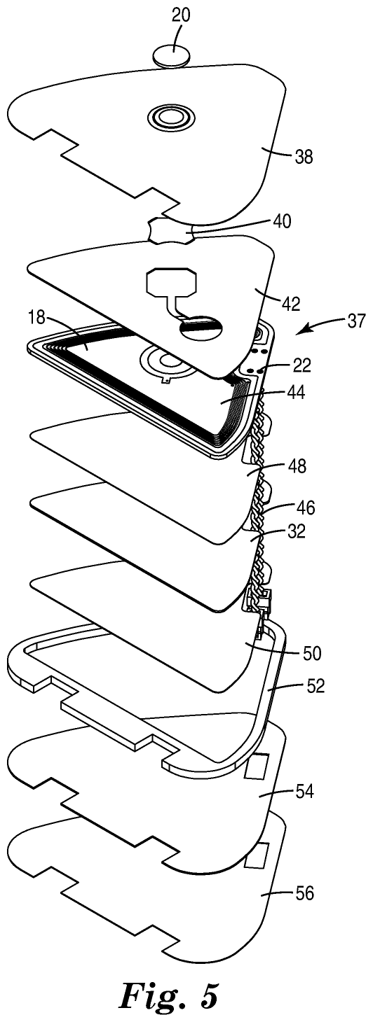

Referring now to FIG. 5, there is shown an exploded view of an example substrate assembly 37. The substrate assembly 37 includes several layers that are substantially commensurate in length and width to provide for a streamlined assembly and to encompass less space within the housing 16. In an exemplary configuration, the actuator 20, which may be silicone, is the distal most component of the substrate 18 and protrudes a distance away from the substrate. A dome retainer 38, which may be polyester and commensurate in size with the ferrite shielding 32 is configured to provide a base with the actuator 20. The actuator 20 further is disposed atop a metal housing 40, which may be dome shaped to provide a conductive contact surface for actuation of the PTT assembly.

In the illustrated embodiment, a switch spacer 42 is further included. In an exemplary configuration, the switch spacer 42 is substantially commensurate in size with the dome retainer 38 and is configured to space between the dome retainer and the circuitry 44 of the PTT assembly. The circuitry 44, which may be a single or multi-layer PCB, or a single or double sided PCB, includes the NFC antenna 22 as discussed above, as well as the circuitry for the PTT assembly all etched or otherwise coupled to the substrate 18. A plurality of conductors 46, e.g., wires, extends from the circuitry 44 and includes wires for the PTT actuator 20 and the NFC antenna 22 for electrical coupling to other communication components within the mask 12. For example, the plurality of conductors 46 may be coupled with a corresponding connector of a microphone (not shown) for PTT communication, as discussed in more detail below. A PCB spacer 48 may be included and configured to space the circuitry 44 from the ferrite shielding 32. A shield spacer 50 may be subjacent to the ferrite shielding 32, which is configured to engage a gasket 52, which surrounds the shield spacer 50. Subjacent to the gasket 52 may be a layer including a polycarbonate resin thermoplastic 54, such as Lexan, which is further coupled to an adhesive 56, which couples the substrate assembly 37 to the housing 16. When the components of the substrate assembly 37 are combined within the housing 16, they are substantially co-axial to provide for a slim profile for the components. It is understood that not all of the components shown in FIG. 5 may be used and implemented as part of the substrate assembly 37, and that implementations are not limited to all and/or only the components shown in FIG. 5.

In an exemplary use of the communications assembly 10, a wearer of the mask 12 with the communications assembly 10 may move within proximity of another wearer of a second mask 12 that also has the communications assembly 10. For example, the masks 12 each includes the NFC antenna 22 and when they are placed within a predetermined distance for NFC communication, for example, within 4 centimeters, the communications assemblies 10 of each of the masks 12 become paired as a group for communication between the masks 10. The details of how communication pairing is implemented with respect to the use of the NFC antenna 22 is beyond the scope of this disclosure. In such a configuration, actuation of the PTT actuator 20 causes activation of a microphone (not shown) within the mask 12 for communication between members of the group whose masks have been paired by NFC communication. Alternatively, actuation of the PTT actuator 20 may cause firmware of the communications assembly 10 to activate a microphone or enable a BLUETOOTH command which initiates a virtual PTT with a connected device and open the microphone for acquisition of audio data.

It will be appreciated by persons skilled in the art that the present embodiments are not limited to what has been particularly shown and described herein above. In addition, unless mention was made above to the contrary, it should be noted that all of the accompanying drawings are not to scale. A variety of modifications and variations are possible in light of the above teachings.

1. A communications assembly for a mask, the assembly comprising:
a housing configured to couple to the mask, the housing including:
a substrate;
a push-to-talk (PTT) actuator coupled to the substrate; and
a near field communication (NFC) antenna coupled to the substrate.

2. The assembly of claim 1, wherein the NFC antenna is at least partially circumferentially disposed about a peripheral region of the substrate.

3. The assembly of claim 1, further including a resilient membrane coupled to housing and configured to engage the PTT actuator when depressed.

4. The assembly of claim 3, further including a bezel, and wherein the resilient membrane is at least partially retained by the bezel.

5. The assembly of claim 4, wherein when the resilient membrane is disposed within the housing the resilient membrane is substantially co-planar with the housing.

6. The assembly of claim 5, wherein the housing includes at least one tab, and wherein the resilient membrane includes at least one slot configured to engage the at least one tab.

7. The assembly of claim 1, further including ferrite shielding coupled to the substrate.

8. A mask having a frame, comprising:
a housing coupled to the frame, the housing including a communications assembly, the communications assembly including:
a substrate;
a push-to-talk (PTT) actuator coupled to the substrate; and
a near field communication (NFC) antenna coupled to the substrate.

9. The mask of claim 8, wherein the NFC antenna is at least partially circumferentially disposed about a periphery of the substrate.

10. The mask of claim 8, wherein the communications assembly further includes a resilient membrane coupled to the housing configured to engage the PTT actuator when depressed.

11. The mask of claim 10, wherein the communications assembly further includes a bezel, and wherein the resilient membrane is at least partially retained by the bezel.

12. The mask of claim 11, wherein when the resilient membrane is disposed within the housing the resilient membrane is substantially co-planar with the housing.

13. The mask of claim 12, wherein the housing includes at least one tab, and wherein resilient membrane includes at least one slot configured to engage the at least one tab.

14. A mask, comprising:
a housing coupled to the mask, the housing being configured to contour an outer surface of the mask, the housing including a communications assembly, the communications assembly including:
a substrate;
a push-to-talk (PTT) actuator coupled to the substrate;
a resilient membrane coupled to the housing and configured to engage the PTT actuator when depressed;
a bezel coupled to the housing and configured to retain the resilient membrane;
a film disposed between the PTT actuator and the resilient membrane; and
a near field communication (NFC) antenna circumferentially disposed about a peripheral region of the substrate.
